(19) United States
(12) Patent Application Publication
(10) Pub. No.: US 2014/0091986 A1
(43) Pub. Date: Apr. 3, 2014

(54) INFORMATION DISPLAY APPARATUS, CONTROL METHOD, AND COMPUTER PROGRAM PRODUCT

(71) Applicant: Kabushiki Kaisha Toshiba, Tokyo (JP)

(72) Inventor: Takayasu Tsuchiuchi, Kanagawa (JP)

(21) Appl. No.: 13/928,102

(22) Filed: Jun. 26, 2013

(30) Foreign Application Priority Data
Sep. 28, 2012 (JP) 2012-217251

(51) Int. Cl. G06F 3/14

(52) U.S. Cl. CPC G06F 3/1423
USPC 345/2.3

(57) ABSTRACT

According to one embodiment, an information display apparatus includes display, link module, input module, detector, determination module, and controller. The display displays a screen. The link module links to an external device, and causes the display to display a screen based on information provided by the external device. The input module receives an input operation with respect to the information display apparatus. The detector detects an operation content received by the input module as a user operation. The determination module compares the user operation and an operation condition corresponding to an operation of each of the external device and the information display apparatus with each other, and determines which of the external device and the information display apparatus is a target device of the user operation. The controller causes the target device determined by the determination module to perform a processing corresponding to the user operation.

### CROSS-REFERENCE TO RELATED APPLICATIONS

This application is based upon and claims the benefit of priority from Japanese Patent Application No. 2012-217251, filed Sep. 28, 2012, the entire contents of which are incorporated herein by reference.

### FIELD

Embodiments described herein relate generally to an information display apparatus, a control method, and a computer program product.

### BACKGROUND

Many stationary (floor-standing) information display apparatuses such as a television generally employ remote operations using a remote controller. For example, there has conventionally been proposed a technology in which a plurality of operations for a television are consistently performed by using one remote controller.

Recently, there exists a portable information display apparatus comprising a touch panel or other input device, such as a Smartphone and a tablet terminal. Users can operate these apparatuses directly with their fingers or a stylus pen, for example, on the input device. In addition, there exists a display system in which related information related to the information displayed on the stationary (floor-standing) information display apparatus is displayed on the portable information display apparatus, by linking the information display apparatus to the stationary (floor-standing) information display apparatus described above.

However, according to the aforementioned display method, a user holding the portable information display apparatus has to shift the remote controller from one hand to the other in order to operate the stationary (floor-standing) information display apparatus. As a result, operability of the stationary (floor-standing) information display apparatus is low.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of an example of a configuration of an information display system according to an embodiment;

FIG. 2 is an exemplary diagram of an example of a hardware configuration of a television illustrated in FIG. 1, in the embodiment;

FIG. 3 is an exemplary diagram of an example of a hardware configuration of a tablet terminal illustrated in FIG. 1, in the embodiment;

FIG. 4 is an exemplary diagram of an example of a functional configuration of the television and the tablet terminal in the embodiment;

FIG. 5A is an exemplary diagram of an example of a display screen displayed on a display of the television, in the embodiment;

FIG. 5B is an exemplary diagram of an example of a display screen displayed on a display of the tablet terminal, in the embodiment;

FIG. 6 is an exemplary schematic view of an example of an operation determination table stored in a storage module of the tablet terminal, in the embodiment;

FIG. 7A is an exemplary diagram for explaining an example of an operation performed at the tablet terminal, in the embodiment;

FIG. 7B is an exemplary diagram for explaining a processing performed in the television in accordance with the operation illustrated in FIG. 7A, in the embodiment;

FIG. 7C is an exemplary diagram for explaining a display screen displayed on the display of the tablet terminal according the processing illustrated in FIG. 7B, in the embodiment;

FIG. 8A is an exemplary diagram for explaining an example of an operation performed at the tablet terminal, in the embodiment;

FIG. 8B is an exemplary diagram for explaining a processing performed in the television in accordance with the operation illustrated in FIG. 8A, in the embodiment;

FIG. 8C is an exemplary diagram for explaining a display screen displayed on the display of the tablet terminal in accordance with the processing illustrated in FIG. 8B, in the embodiment;

FIG. 9 is an exemplary diagram for explaining an example of an operation performed at the tablet terminal, in the embodiment; and

FIG. 10 is an exemplary flowchart of a link processing performed between the television and the tablet terminal, in the embodiment.

### DETAILED DESCRIPTION

In general, according to one embodiment, an information display apparatus comprises a display, a link module, an input module, a detector, a determination module, and a controller. The display is configured to display a screen. The link module is configured to link to an external device, and to cause the display to display a screen based on information provided by the external device. The input module is configured to receive an input operation with respect to the information display apparatus. The detector is configured to detect an operation content received by the input module as a user operation. The determination module is configured to compare the user operation and an operation condition corresponding to an operation of each of the external device and the information display apparatus with each other, and to determine which of the external device and the information display apparatus is a target device of the user operation. The controller is configured to cause the target device determined by the determination module to perform a processing corresponding to the user operation.

An information display apparatus, a control method, and a computer program product according to an embodiment will be described below in detail with reference to the accompanying drawings. The embodiment described below is applied to an information display system comprising a television and a tablet terminal, for example.

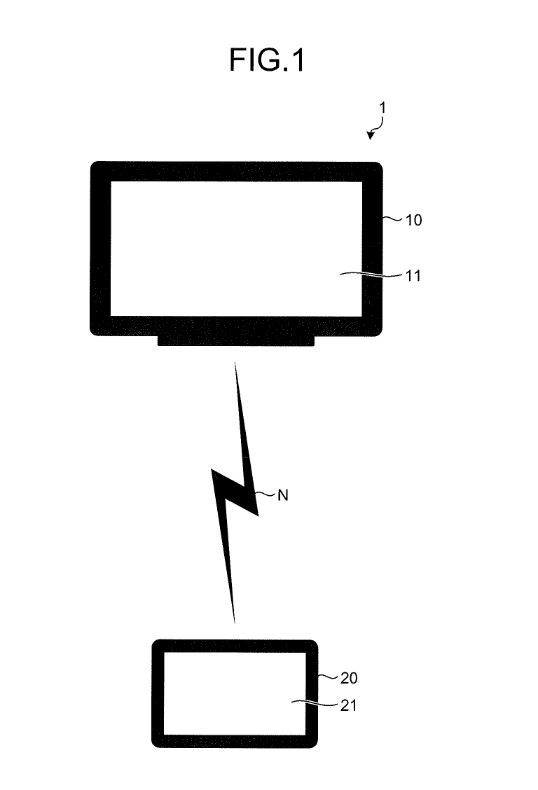

FIG. 1 is an exemplary view of an example of a configuration the information display system according to the embodiment. As illustrated in FIG. 1, the information display system 1 comprises a television 10 and one or more tablet terminals 20. The television 10 and the tablet terminal 20 are communicatively coupled to each other through a network N such as a local area network (LAN) or the Internet, wiredly or wirelessly.

The television 10 serves as a stationary (floor-standing) information display apparatus such as a television broadcast receiver that receives a digital television broadcast, and a smart television capable of receiving various types of information from the Internet, and displays on a display 11 various types of content such as a received television program. The television 10 operates in a linked manner with the tablet terminal 20 upon a request (link request) from the tablet terminal 20.

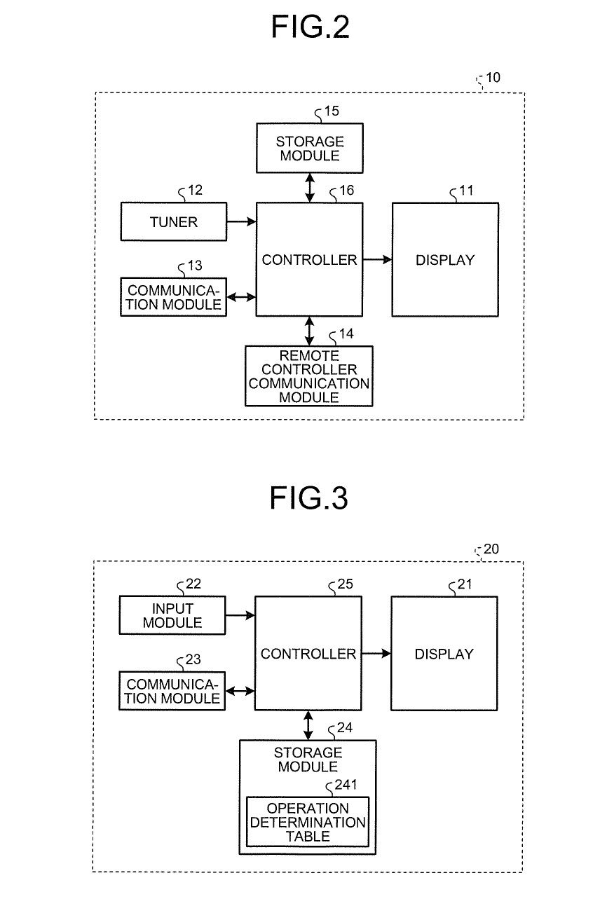

FIG. 2 is a diagram of an example of a hardware configuration of the television 10. As illustrated in FIG. 2, the television 10 comprises the display 11, a tuner 12, a communication module 13, a remote controller communication module 14, a storage module 15, and a controller 16. The television 10 also comprises a speaker or the like, which is not illustrated.

The display 11 serves as a display device such as a liquid crystal display (LCD) and an organic light emitting display (OLED), and displays various types of information under the control of the controller 16. It should be noted that the display screen of the display 11 is configured to be larger than the display screen of a display 21 described later.

The tuner 12 receives a broadcast signal from a broadcast channel not illustrated through an antenna, for example. Specifically, when a specific channel (i.e., broadcast channel) is specified by a channel selection operation by a user, the tuner 12 receives a broadcast signal of the specified channel under the control of the controller 16.

The communication module 13 serves as a communication interface that can be connected to the network N. The communication module 13 transmits and receives various types of information to and from an external device (e.g., the tablet terminal 20 or a server device not illustrated) coupled to the network N under the control of the controller 16.

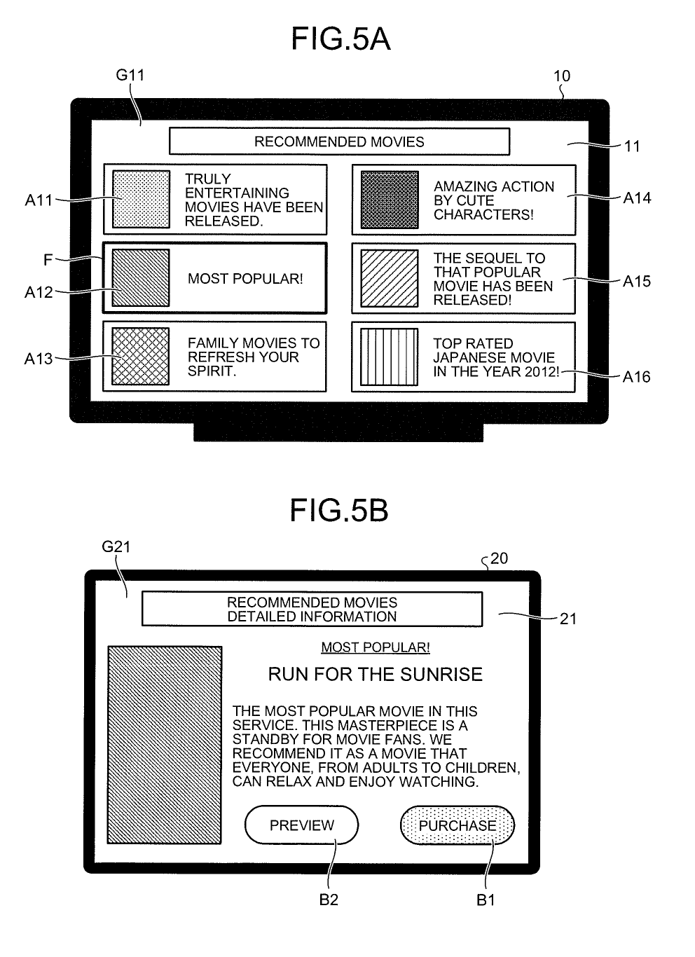

The remote controller communication module 14 comprises a receiver comprising an infrared light receiving element or the Bluetooth (registered trademark) technology, for example, and receives a signal transmitted from a remote controller not illustrated. A user of the television 10 can input various instructions such as to select a channel, to move a focus frame (see FIG. 5A) for focusing onto an object displayed on the display 11, and to move a cursor, using the remote controller.

The storage module 15 comprises a non-volatile recording medium such as a read only memory (ROM), a hard disk drive (HDD), and a solid state drive (SSD) so as to store therein various computer programs and various types of setting information.

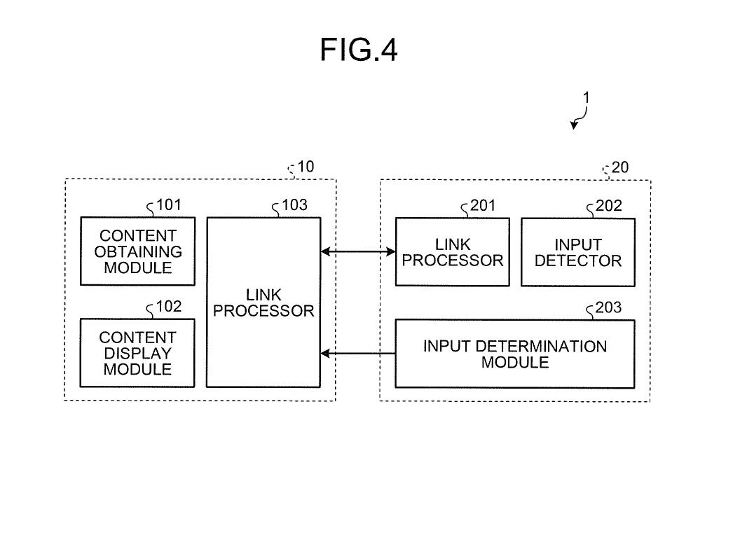

The controller 16 comprises a central processing unit (CPU) and a random access memory (RAM) (both not illustrated), and entirely controls the operations of the television 10 by collaborating with a computer program stored in the storage module 15. The controller 16 also implements the functional modules (see FIG. 4) according to link operations with the tablet terminal 20 by collaborating with the program stored in the storage module 15.

With reference to FIG. 1 again, the tablet terminal 20 serves as a portable information display apparatus which is used in a state in which a user holds the tablet terminal 20, and displays various types of information on the display 21. The tablet terminal 20 operates in a linked manner with the television 10 by transmitting a link request to the television 10.

FIG. 3 is a diagram of an example of a hardware configuration of the tablet terminal 20. As illustrated in FIG. 3, the tablet terminal 20 comprises the display 21, an input module 22, a communication module 23, a storage module 24, and a controller 25.

The display 21 serves as a display device such as a liquid crystal display (LCD) and an organic light emitting display (OLED), and displays various types of information under the control of the controller 25.

The input module 22 serves as an input device such as a pointing device, a button, and a switch, and receives various types of instructions and information that are input by a user. As an example of the pointing device, an optically transparent touch panel that is superimposed on an entire or part of the display surface of the display 21 is employed in the embodiment, however, the embodiment is not limited thereto. The input device above may employ a sensor device such as a three-axis acceleration sensor capable of sensing a change of an orientation of the tablet terminal 20 (e.g., rotation or tilt).

The communication module 23 serves as a communication interface that can be connected to the network N. The communication module 23 transmits and receives various types of information to and from an external device (e.g., the television 10 or a server device not illustrated) connected to the network N under the control of the controller 25.

The storage module 24 comprises a non-volatile recording medium such as a ROM, an HDD, and an SSD so as to store therein various computer programs and setting information. An example of setting information stored in the storage module 24 is an operation determination table 241. The operation determination table 241 will be exemplified later.

The controller 25 comprises a CPU and a RAM (both not illustrated), and entirely controls the operations of the tablet terminal 20 by collaborating with a computer program stored in the storage module 24. The controller 25 also implements the functional modules (refer to FIG. 4) corresponding to link operations with the television 10 by collaborating with a computer program stored in the storage module 24.

With reference to FIG. 4, a functional configuration corresponding to a link function between the television 10 and the tablet terminal 20 is explained. FIG. 4 is a diagram of a functional configuration of the television 10 and the tablet terminal 20.

As illustrated in FIG. 4, the controller 16 of the television 10 implements a content obtaining module 101, a content display module 102, and a link processor 103 as the functional modules of the television 10 by collaborating with a computer program stored in the storage module 15.

The content obtaining module 101 obtains data broadcasting contained in broadcast signals received by the tuner 12 as broadcast content. The content obtaining module 101 also obtains website content from a server device, not illustrated, by accessing the server device through the communication module 13 based on a user's operation via the remote controller or access information comprised in an electronic program guide.

The content display module 102 displays the broadcast content and the website content (collectively referred to as “contents”, hereinafter) obtained by the content obtaining module 101 on the display 11. All or part of the functions of the content obtaining module 101 and the content display module 102 may be implemented using a web client program such as a web browser.

The link processor 103 serves as a functional module, and performs a processing so as to be operated in a linked manner with the tablet terminal 20 that has accessed the television 10. Specifically, when a link request is received from the tablet terminal 20 through the communication module 13, the link processor 103 temporarily stores identification information comprised in the link request in a RAM and/or the like. The identification information comprises specific information such as: an IP address and a host name that are unique to the television 10; and/or version information representing the name and the version of a computer program (application program) that corresponds to implementation of a link processor 201, which will be described later.

The link processor 103 transmits, to the tablet terminal 20 corresponding to the temporarily stored identification information, application information related to the link with the television 10. The link processor 103 thereby provides the tablet terminal 20 with an operation environment required for the link to the television 10 as necessary. The application information comprises a framework and various computer programs (e.g., a script, JAVA (registered trademark), an applet) related to screen displays, or the information to obtain the framework and various computer programs (e.g., a uniform resource locator, URL). If the version information of the link processor 201 used in the tablet terminal 20 is comprised in the identification information, the application information corresponding to the version information is transmitted.

After the link with the tablet terminal 20 is established, the link processor 103 transmits (provides) display information in which information to be displayed on the tablet terminal 20 is specified to the tablet terminal 20. In other words, the link processor 103 provides the tablet terminal 20 with the display information, thereby displaying a screen which is based on the display information on the tablet terminal 20. The display information may be image data or video data itself to be displayed on the tablet terminal 20, or address information of a server device storing a content of a screen such as an image to be displayed.

The information displayed based on the display information is not limited. For example, information related to the content displayed on the display 11 by the content display module 102 may be displayed. This example will be described below with reference to FIGS. 5A and 5B.

FIG. 5A is a diagram of an example of a display screen displayed on the display 11 of the television 10. FIG. 5B is a diagram of an example of a display screen displayed on the display 21 of the tablet terminal 20.

In the information display system 1, a user watching the television 10 is present at a position away from the television 10, in general. When a plurality of contents are presented on the television 10, as illustrated in FIG. 5A, the contents are schematically presented as objects (A11 to A16) to increase the visibility of the contents. A screen G11 in FIG. 5A exemplifies outlined explanations for six movies displayed on the display 11 as the objects A11 to A16 that can be selected using a focus frame F.

By contrast, a user generally holds the tablet terminal 20 while using it. The user can therefore recognize small characters on the tablet terminal 20 more readily than on the television 10. This enables designing the screen configuration in the tablet terminal 20, taking advantage that more detailed information can be displayed thereon than the television 10.

Thus, in the following, it is considered a difference in a viewing mode between the television 10 and the tablet terminal 20, and there is explained a mode in which detailed information for complementing the outlined explanations displayed on the television 10 is displayed on the tablet terminal 20.

Specifically, after the link to the tablet terminal 20 is established, the link processor 103 transmits to the tablet terminal 20 the display information for displaying the detailed information on the object A12 on which the focus frame F is disposed out of the objects A11 to A16 displayed on the display 11 of the television 10. Accordingly, as illustrated in FIG. 5B, in the tablet terminal 20, a screen G21 representing the detailed information of the object A12 is displayed on the display 21 by the function of the link processor 201, which will be described later.

The position of the focus frame F displayed on the display 11 of the television 10 can be moved to any direction by operating the remote controller not illustrated. However, the user operating the tablet terminal 20 has to hold the remote controller of the television 10 instead of the tablet terminal 20 to operate the television 10. This results in low operability and inconvenience.

Therefore, according to the information display system 1 of the embodiment, the television 10 and the tablet terminal 20 in a link relationship with respect to each other collaborate with each other so that screen operations of the screen displayed on the display 11 of the television 10 can be performed from the tablet terminal 20. Specifically, in the television 10, the screen operation such as to move the focus frame F is performed in accordance with the control information transmitted from the tablet terminal 20, as described later. Consequently, seamless operability is provided between the television 10 and the tablet terminal 20. Further, the television 10 transmits to the tablet terminal 20 the display information in which the screen operation is reflected. Consequently, a screen which is based on the display information is displayed on the display 11.

With reference to FIG. 4 again, the controller 25 of the tablet terminal 20 collaborates with a computer program stored in the storage module 24, thereby implementing the link processor 201, an input detector 202, and an input determination module 203, as the functional module of the tablet terminal 20.

The link processor 201 serves as a functional module and controls the tablet terminal 20 to operate in a linked manner with the television 10. Specifically, the link processor 201 transmits the link request comprising identification information of the tablet terminal 20 through the communication module 23 to the television 10, thereby requesting the television 10 for the link operation with the tablet terminal 20.

Once application information is received from the television 10 in response to transmission of the link request, the link processor 201 controls operations of the tablet terminal 20 based on the application information, so as to establish the link to the television 10. Then, when display information is received from the television 10 after the link to the television 10 is established, the link processor 201 subsequently displays a screen based on the display information on the display 21.

When image data or video data itself is received as the display information, the link processor 201 causes the display 21 to display the data by, for example, playing the data. Further, when address information of a server device storing a screen configuration such as an image to be displayed is received as the display information, the link processor 201 accesses the server device indicated by the address information so as to obtain the contents of the screen from the server device, thereby displaying the screen based on the contents of the screen on the display 21. The input detector 202 and the input determination module 203 may be implemented by the application information transmitted from the television 10.

The input detector 202 detects a user operation input through the input module 22. Specifically, the input detector 202 obtains a position where the user operation is input through the touch panel (the input module 22) as a coordinate value on the display screen of the display 21. The input detector 202 also detects an operation content performed during the touching based on the change in the coordinate value, as a user operation. Examples of the operation content detected are a distance between a coordinate of a starting point and a coordinate of an ending point involved with a tap operation or a flick (slide) operation (hereinafter, referred to as a stroke distance) and a direction of the operation (slide direction).

When a sensor device such as an acceleration sensor is employed as the input module 22, a change of an orientation (e.g., rotation or tilt) of the tablet terminal 20 is detected as the user operation based on the detection result.

The input determination module 203 determines (identifies) a target device (operation target device) of the user operation detected by the input detector 202 while linking to the television 10 based on the operation determination table 241 stored in the storage module 24. The input determination module 203 causes the operation target device to execute a processing corresponding to the user operation.

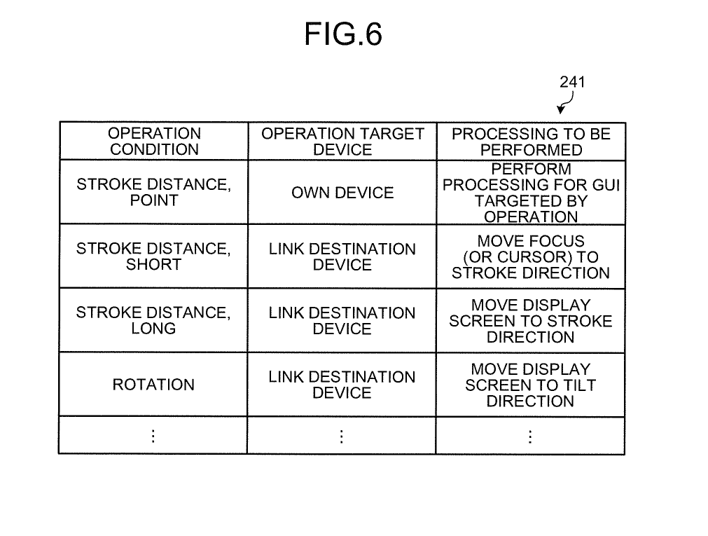

FIG. 6 is a schematic view of an example of the operation determination table 241 stored in the storage module 24 of the tablet terminal 20. As illustrated in FIG. 6, the operation determination table 241 comprises: an operation condition (or operation content) for each operation of the tablet terminal 20 or the link destination device (the television 10); the operation target device (the tablet terminal 20 or the link destination device); and a processing to be performed by the input determination module 203. These are registered in the operation determination table 241 in association with each other.

FIG. 6 illustrates an example in which “stroke distance, point”, “stroke distance, short” and “stroke distance, long” are registered in the operation determination table 241 as the operation conditions related to the input module 22. Here, “Stroke distance, point” means that the stroke distance is zero or within a predetermined minor range. “Stroke distance, short” means that the stroke distance is within a predetermined range of a first length. “Stroke distance, long” means that the stroke distance is within a predetermined range of a second length, which is longer than the first length. As another operation condition relating to the input module 22 (the acceleration sensor), “rotation” is registered, which means that the tablet terminal 20 is rotated by a predetermined angle or more while being kept horizontal. “Being kept horizontal” means that the relative angle of the display surface of the display 21 with respect to a user is maintained almost horizontally.

The input determination module 203 compares each of the operation conditions registered in the operation determination table 241 with the user operation detected by the input detector 202, and determine (identify) which of the operation conditions registered in the operation determination table 241 corresponds to the user operation. Once the input determination module 203 identifies an operation condition corresponding to the user operation, the input determination module 203 controls the operation target device registered in the table associated with the user operation to perform a processing defined in “operation” associated with the operation target device in the operation determination table 241.

For example, when a tap operation is input on a specific GUI (e.g., button B1 or B2) on the screen G21 displayed on the display 21 illustrated in FIG. 5B, the input detector 202 detects the tap operation as the user operation. Then, the input determination module 203 determines that the user operation detected by the input detector 202 corresponds to the operation condition “stroke distance, point” based on the operation determination table 241 in FIG. 6. Subsequently, in accordance with a content of a processing in the operation determination table 241, the input determination module 203 causes the controller 25 (or the link processor 201) to perform a processing for the GUI to which the user operation has been input in the tablet terminal 20, i.e., the operation target device.

More specifically, when the tap operation is input on the button B1 used for purchasing movie content, the controller 25 controls the tablet terminal 20 to perform electronic payment processing or the like corresponding to the purchase of the movie content. Alternatively, when the tap operation is input on the button B2 used for previewing the movie content, the controller 25 causes the tablet terminal 20 to access a video distribution server, for example, to obtain a preview video of the movie content. It should be noted that some GUIs (buttons) are set in advance associated with a command to be executed or an access destination.

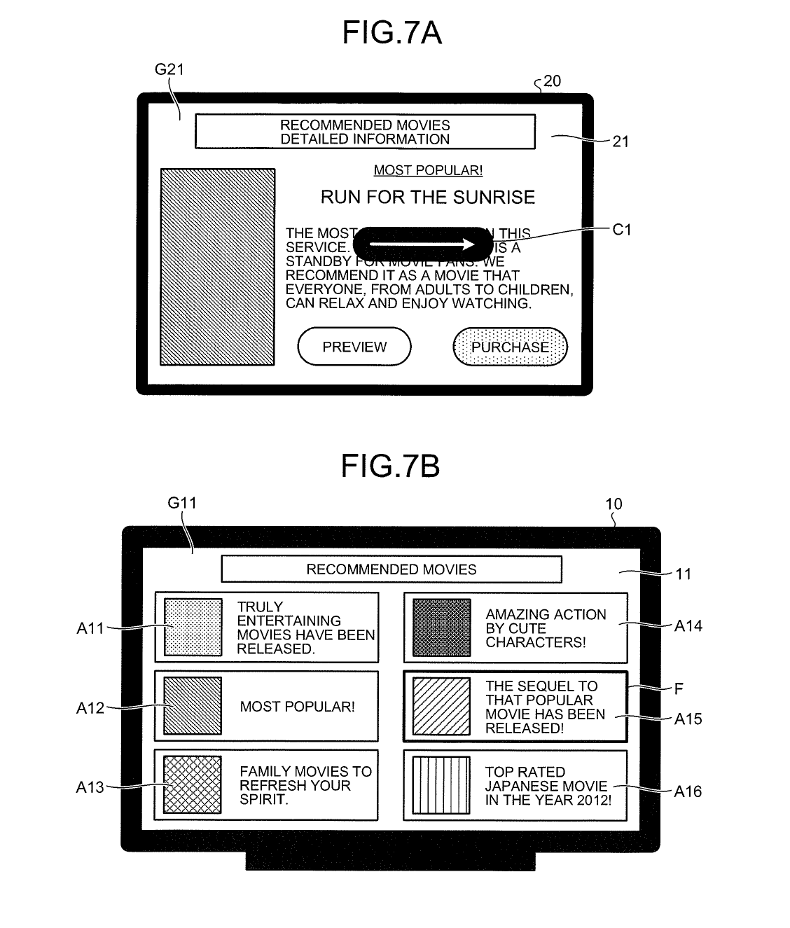

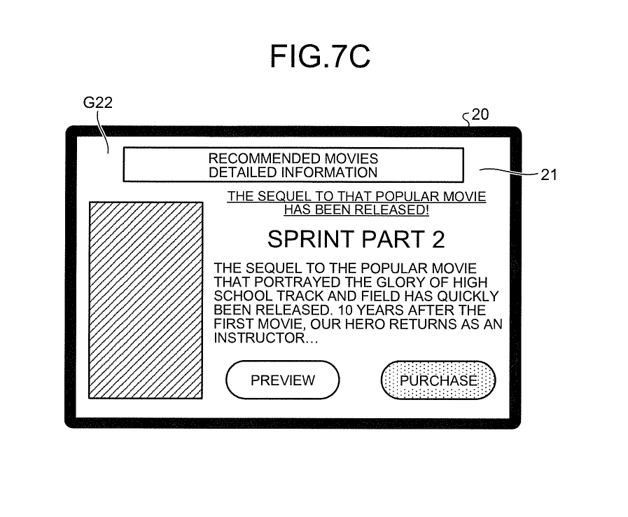

When a stroke operation C1 with a stroke distance of the first length to the right direction, as illustrated in FIG. 7A, is input on the screen G21 displayed on the display 21 illustrated in FIG. 5B, the input detector 202 detects the stroke operation C1 as the user operation. In this example, the input determination module 203 determines that the user operation detected by the input detector 202 corresponds to the operation condition “stroke distance, short” abased on the operation determination table 241 in FIG. 6. Subsequently, in accordance with a processing of an operation in the operation determination table 241, the input determination module 203 generates a command for moving the focus frame F (or a cursor) displayed on the display 11 of the television 10 to the right direction, which is the same direction as the user operation. The input determination module 203 then transmits the command to the television 10, i.e., the operation target device, as the control information.

When the link processor 103 of the television 10 receives the control information from the tablet terminal 20, the link processor 103 executes a processing to move the focus frame F position illustrated in FIG. 5A to the right direction, in accordance with the command comprised in the control information. This corresponds to a state illustrated in FIG. 7B in which the focus frame F is arranged on an object A15. Further, the link processor 103 transmits (provides) display information corresponding to the object A15 to which the focus frame F is moved, to the tablet terminal 20. Meanwhile, the link processor 201 of the tablet terminal 20 displays a screen G22 providing detailed information corresponding to the object A15 as illustrated in FIG. 7C, on the display 21, based on the display information newly provided from the link processor 103 of the television 10.

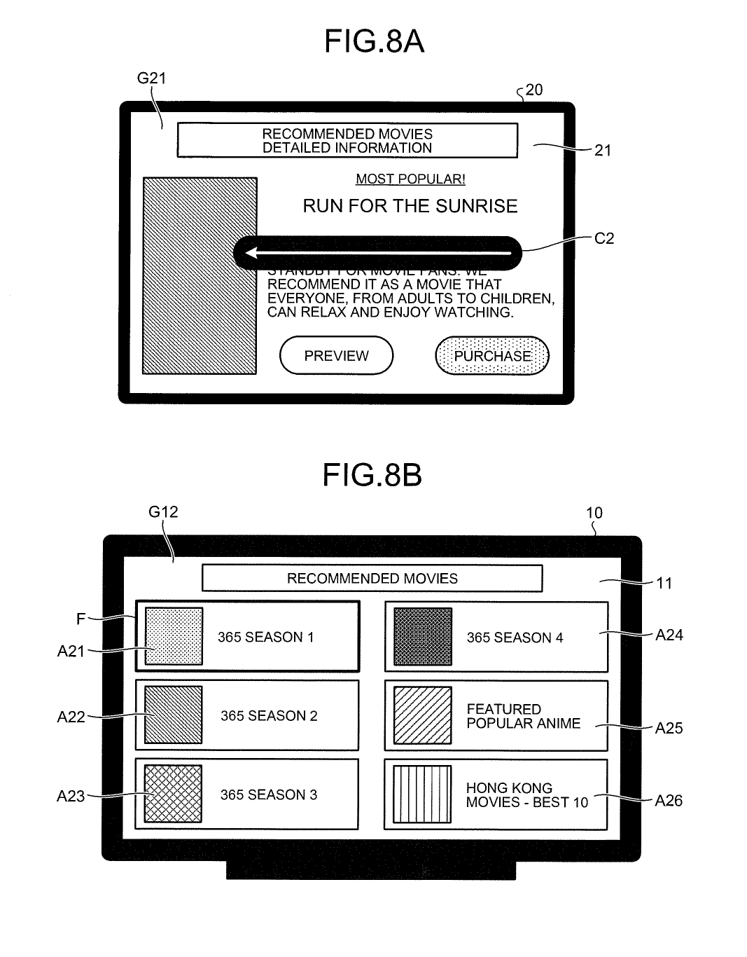

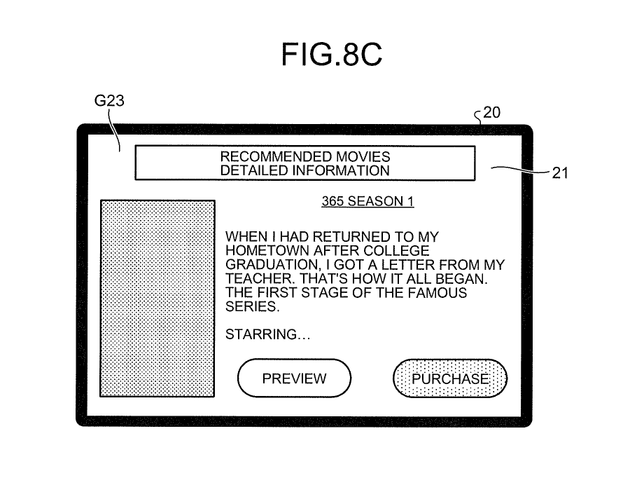

When a stroke operation C2 with a stroke distance of the second length to the left direction, as illustrated in FIG. 8A, is input on the screen G21 displayed on the display 21 illustrated in FIG. 5B, the input detector 202 detects the stroke operation C1 as the user operation. In this example, the input determination module 203 determines that the user operation detected by the input detector 202 corresponds to the operation condition “stroke distance, long” based on the operation determination table 241 in FIG. 6. Subsequently, in accordance with a processing of an operation defined in the operation determination table 241, the input determination module 203 generates a command to move the screen displayed on the display 11 of the television 10 to the left direction, which is the same direction as the user operation. The input determination module 203 then transmits a command to the television 10, i.e., the operation target device, as the control information.

When the link processor 103 of the television 10 receives the control information from the tablet terminal 20, the link processor 103 executes a processing to move (scroll) the screen illustrated in FIG. 5A to the left direction, in accordance with the command comprised in the control information. As a result, a screen G12 in which objects A21 to A26 are arranged as illustrated in FIG. 8B is displayed, for example. Then, the link processor 103 transmits (provides) the display information corresponding to the object A21 on which the focus frame F is arranged in the screen G12. Meanwhile, the link processor 201 of the tablet terminal 20 displays a screen G23 providing detailed information corresponding to the object A21 as illustrated in FIG. 8C, on the display 21, based on the display information newly provided from the link processor 103 of the television 10.

The tracks of the stroke operations C1 and C2 illustrated in FIGS. 7A or 8A only represent the movement of a user's finger or a stylus pen. However, the tracks may actually be displayed on the display 21 by the input detector 202 by emphasizing and displaying colors around the pixels corresponding to the stroke position.

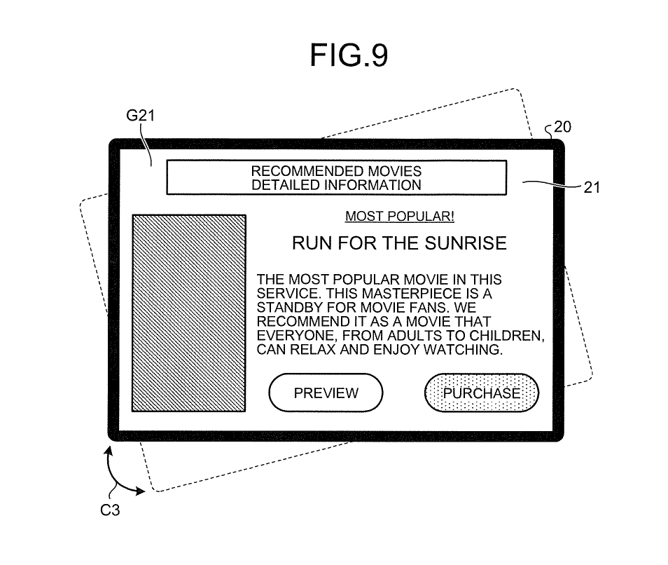

Further, when a rotation operation C3 is input to the screen G21 displayed on the display 21 as illustrated in FIG. 9 while the screen displayed on the tablet terminal 20 is in the state of the screen G21 illustrated in FIG. 5B, the input detector 202 detects the rotation operation C3 as the user operation. Here, the rotation operation C3 is an operation such that the horizontally maintained tablet terminal 20 is rotated to the left direction by a predetermined angle and then brought back to the original state. Further, in this case, the input determination module 203 determines that the user operation detected by the input detector 202 corresponds to the operation condition “rotation”, based the operation determination table 241 in FIG. 6. Subsequently, in accordance with the operation defined in the operation determination table 241, the input determination module 203 generates a command to move the screen displayed on the display 11 of the television 10 to the left direction, which is the same direction as the user operation. The input determination module 203 then transmits the command to the television 10, i.e., the operation target device, as the control information. In this example, the same processing is executed as the processing illustrated in FIG. 8B in the television 10, thus the same screen G23 illustrated in FIG. 8C is displayed in the display 21 of the tablet terminal 20.

As described above, with the configuration of the tablet terminal 20 in the embodiment, it is determined which of the tablet terminal 20 or the television 10 is targeted by the user operation input on the tablet terminal 20. When the television 10 is targeted, the television 10 is controlled to perform the operation (screen operation) corresponding to the user operation. This enables a user of the tablet terminal 20 to operate the television 10 without holding the remote controller instead of the tablet terminal 20, thereby increasing the operability of the television 10 and the tablet terminal 20.

According to the embodiment, when the operation target device is the television 10, a command corresponding to the user operation is generated and transmitted as the control information; however, the embodiment is not limited thereto. The user operation itself (e.g., the stroke distance, the stroke direction, the rotational direction) may be transmitted as the control information, for example.

Further, when the operation target device is the television 10, the notification may be performed by, for example, the input determination module 203 such that the screen displayed on the display 21 is dimmed or a certain indication representing that the operation is with respect to the television 10 is displayed on the display 21. This enables a user to know which of the television 10 and the tablet terminal 20 is targeted by the operation, thereby increasing the convenience of operations on the television 10 and the tablet terminal 20.

The notification may be performed after an operation input on the input module 22 for the television 10 is completed or when a predictive operation for the television 10 is input on the input module 22. In other words, the input determination module 203 may perform the notification when it is determined that an operation for the television 10 has been input, or alternatively, when, although it cannot yet be determined that an operation for the television 10 is input, it can be determined that such operation has been input if the input of the operation was continued. For example, with reference to the conditions illustrated in FIG. 6, although the stroke distance is shorter than the length defined for “short” or “long”, i.e., it cannot yet be determined that an operation for the television 10 has been input, the input determination module 203 may inform as long as the stroke distance is larger than the length defined for “point”. That is to say, the input determination module 203 may perform the notification when the operation input to the input module 22 is excluded from the condition for determining that the operation is input for the tablet terminal 20.

The registered contents in the operation determination table 241 are not limited to the examples illustrated in FIG. 6, and any contents can be set depending on the specifications on the tablet terminal 20 or the GUI. For example, in FIG. 6, the rotation operation of the tablet terminal 20 is registered as the operation condition corresponding to the operation for the television 10; however, it may be registered as an operation condition corresponding to an operation for the tablet terminal 20. Further, the tilt operation in which the tablet terminal 20 is tilted in the direction perpendicular to the direction (horizontal direction) along the display surface of the tablet terminal 20 may be registered as an operation condition for the television 10 or the tablet terminal 20. Furthermore, when a touch panel with multi-point detection is used as the input module 22, different types of processing may be registered depending on whether the input operation is a single-point input or a multi-point input (e.g., fixing at one point while sliding at another point).

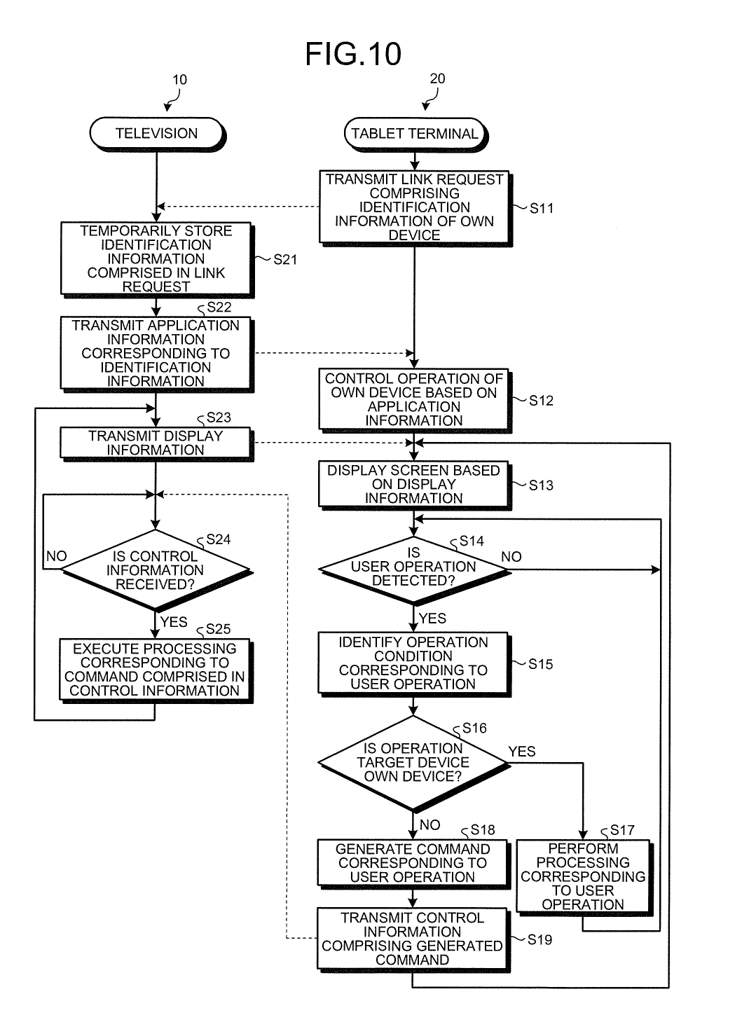

With reference to FIG. 10, operations on the information display system 1 will now be described. FIG. 10 is a flowchart of a link processing performed in the television 10 and the tablet terminal 20. It should be noted that the content obtained by the content obtaining module 101 is displayed on the display 11 in the television 10, under the control of the content display module 102, while this processing is performed.

When the link to the television 10 is directed by a user operation through the input module 22 in the tablet terminal 20, the link processor 201 transmits a link request comprising identification information of the tablet terminal 20 to the television 10 (S11).

In the television 10, once the link processor 103 receives the link request transmitted from the tablet terminal 20, the link processor 103 temporarily stores the identification information comprised in the link request in a recording medium such as a RAM or the storage module 15 (S21). The link processor 103 then transmits application information corresponding to the identification information (comprising the version information) to the tablet terminal 20 (S22).

In the tablet terminal 20, once the link processor 201 receives the application information transmitted from the television 10, the link processor 201 controls an operation of the tablet terminal 20 based on the application information (S12). Through the processing (S11, S12, S21, and S22), the link between the television 10 and the tablet terminal 20 is established.

After the link is established with respect to the tablet terminal 20, the link processor 103 of the television 10 transmits display information to the tablet terminal 20 (S23). Accordingly, the link processor 201 of the tablet terminal 20 performs a processing so as to display a screen based on the display information provided from the television 10 on the display 21 of the tablet terminal 20 (S13).

The input detector 202 of the tablet terminal 20 waits for the user operation to be detected (No at S14). If an operation is input through the input module 22, the input detector 202 detects the user operation (S14).

The input determination module 203 compares each of operation conditions registered in the operation determination table 241 with the user operation detected by the input detector 202 so as to identify an operation condition corresponding to the user operation (S15). The input determination module 203 then determines whether the operation target device is the tablet terminal 20 based on a record of the identified operation condition (S16). If it is determined that the operation target device is the tablet terminal 20 (Yes at S16), the input determination module 203 causes the controller 25 to perform a processing corresponding to the user operation based on the GUI corresponding to the coordinate value at which the user operation is input (S17). Then, the processing returns to S14.

If it is determined that the operation target device is a link destination device (the television 10) at S16 (No at S16), the input determination module 203 generates a command corresponding to the user operation (S18). The input determination module 203 transmits the generated command to the television 10 as control information (S19). Then, the processing returns to S13.

In the television 10, the link processor 103 waits for the control information to be transmitted from the tablet terminal 20 (No at S24). If the link processor 103 receives the control information transmitted from the tablet terminal 20 (Yes at S24), the link processor 103 executes the processing corresponding to the command comprised in the control information. This achieves screen operations such as focus movement and screen scroll (S25). The link processor 103 returns processing to S23 so as to transmit the display information reflecting the result of processing at S25 to the tablet terminal 20.

As described above, according to the embodiment, a user of the tablet terminal 20 can direct an operation for the television 10 and the tablet terminal 20 through the input module 22 of the tablet terminal 20, whereby operability of the tablet terminal 20 is increased.

The operation (user operation) itself that is input to the tablet terminal 20 indicates the operation target device, thereby a user only has to input a user operation through the input module 22 to operate the tablet terminal 20 and the television 10. This eliminates dividing an operation field (touch panel field) for each operation target device, and eliminates a switching operation to switch the operation target device. Consequently, operations are simplified and the operability of the tablet terminal 20 is increased.

The embodiment described above has been presented by way of example only, and is not intended to limit the scope of the invention. The embodiment described above may be embodied in a variety of other forms; furthermore, various omissions, substitutions, and changes maybe made without departing from the spirit of the invention. The accompanying claims and their equivalents are intended to cover such forms or modifications as would fall within the scope and spirit of the inventions. The embodiment described above and their modifications are comprised in the scope and abstract of the invention, and also in the invention described in the accompanying claims and the scope of equivalents.

For example, in the above-described embodiment, the information display apparatus of the embodiment is applied to the tablet terminal 20. The embodiment, however, may be applied to other information display apparatuses such as a mobile phone or a Smartphone, an operation of which is displayed and performed in user's hand. Also in the above-described embodiment, the television 10 is employed for a device linking to the tablet terminal 20, however, another tablet terminal 20 comprising the functional modules of the television 10 may be used.

The computer program executed in the television 10 and the tablet terminal 20 according to the embodiment may be provided in a manner recorded as an installable or executable file format in a computer-readable recording medium, such as a compact disk read-only memory (CD-ROM), a flexible disk (FD), a compact disk recordable (CD-R), and a digital versatile disk (DVD).

The computer program executed in the television 10 and the tablet terminal 20 according to the embodiment may be provided in a manner stored in a computer connected to a network such as the Internet so as to be downloaded through the network. The computer program executed in the television 10 and the tablet terminal 20 according to the embodiment may also be provided or distributed over a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

What is claimed is:

1. An information display apparatus comprising:
a display configured to display a screen;
a link module configured to link to an external device, and to cause the display to display a screen based on information provided by the external device;
an input module configured to receive an input operation with respect to the information display apparatus;
a detector configured to detect an operation content received by the input module as a user operation;
a determination module configured to compare the user operation and an operation condition corresponding to an operation of each of the external device and the information display apparatus with each other, and to determine which of the external device and the information display apparatus is a target device of the user operation; and
a controller configured to cause the target device determined by the determination module to perform a processing corresponding to the user operation.

2. The information display apparatus of claim 1, wherein
the input module is a pointing device, and
the detector is configured to detect an operation content input through the pointing device as the user operation.

3. The information display apparatus of claim 2, wherein
the pointing device is a touch panel provided on a display surface of the display, and
the detector is configured to detect an operation content input through the touch panel as the user operation.

4. The information display apparatus of claim 3, wherein
a slide operation with respect to the touch panel is defined as the operation condition corresponding to the operation of the external device or the information display apparatus, and
the controller is configured to cause the target device to perform a processing corresponding to a slide direction and a stroke distance of the slide operation detected by the detector as the user operation.

5. The information display apparatus of claim 3, wherein
a touch operation with respect to the touch panel is defined as the operation condition corresponding to the operation of the external device or the information display apparatus, and
the controller is configured to cause the target device to perform a processing corresponding to a position of the touch operation detected by the detector as the user operation.

6. The information display apparatus of claim 1, wherein
the input module is a sensor configured to detect a change of an orientation of the information display apparatus, and
the detector is configured to detect a change in the orientation detected by the sensor as the user operation.

7. The information display apparatus of claim 6, wherein
a rotation operation or atilt operation of the information display apparatus is defined as the operation condition corresponding to the operation of the external device or the information display apparatus, and
the controller is configured to cause the target device to perform a processing corresponding to the rotation operation or the tilt operation detected by the detector as the user operation.

8. The information display apparatus of claim 1, wherein the determination module is configured to perform notification by using the display screen of the display if the determination module determines that the target device is the external device.

9. The information display apparatus of claim 8, wherein the determination module is configured to notify that the target device is the external device by dimming the display screen of the display.

10. A control method executed in an information display apparatus comprising a display configured to display a screen and an input module configured to receive an input operation with respect to the information display apparatus, the control method comprising:
linking to an external device, and causing the display to display a screen based on information provided by the external device;
detecting an operation content received by the input module as a user operation;
comparing the user operation and an operation condition corresponding to an operation of each of the external device and the information display apparatus with each other, and determining which of the external device and the information display apparatus is a target device of the user operation; and
causing the target device determined at the determining to perform a processing corresponding to the user operation.

11. A computer program product having a non-transitory computer readable medium including programmed instructions, wherein the instructions, when executed by a computer of an information display apparatus comprising a display configured to display a screen and an input module configured to receive an input operation with respect to the information display apparatus, cause the computer to perform:
linking to an external device, and causing the display to display a screen based on information provided by the external device;
detecting an operation content received by the input module as a user operation;
comparing the user operation and an operation condition corresponding to an operation of each of the external device and the information display apparatus with each other, and determining which of the external device and the information display apparatus is a target device of the user operation; and
causing the target device determined by the determining to perform a processing corresponding to the user operation.
